(19) United States
(12) Patent Application Publication
(10) Pub. No.: US 2018/0314364 A1
(43) Pub. Date: Nov. 1, 2018

(54) STYLUS AND ELECTRONIC SYSTEM THEREOF

(71) Applicant: EGALAX_EMPIA TECHNOLOGY INC., Taipei City (TW)

(72) Inventor: SHANG-TAI YEH, TAIPEI CITY (TW)

(21) Appl. No.: 15/963,545

(22) Filed: Apr. 26, 2018

Related U.S. Application Data
(60) Provisional application No. 62/490,159, filed on Apr. 26, 2017.

(30) Foreign Application Priority Data
Feb. 26, 2018 (TW) 107106728

(51) Int. Cl. G06F 3/044; G06F 3/0354; G06F 3/038; G08C 17/02

(52) U.S. Cl. CPC G06F 3/044; G08C 17/02; G06F 3/0383; G06F 3/03545

(57) ABSTRACT

The present application provides a stylus for receiving a wireless radio frequency signal emitted from a touch panel or screen. The stylus includes a rod covered by dielectric material for user's handling; an electrode for receiving the wireless radio frequency signal; and a receiving circuit coupled to the electrode, wherein the receiving circuit is placed inside the rod.

### CROSS REFERENCE TO RELATED APPLICATIONS

This application claims priority to U.S. patent application, 62/490,159, filed on Apr. 26, 2017, the disclosure of which is incorporated herein by reference.

### BACKGROUND OF THE INVENTION

### 1. Field of the Invention

The present invention relates to the field of touch sensitive electronic system, and more particularly, to a stylus and an electronic system thereof.

### 2. Description of the Prior Art

A stylus can detect electrical signal emitted from a touch panel/screen to perform certain functions. The electrical signal emitted from the touch panel could be called as “beacon signal”. The beacon signal may be emitted by at least one electrode of the touch panel. In some examples, the touch panel may emit the beacon signal via multiple electrodes which are in parallel to be detected by the stylus.

In one example, the stylus can use the beacon signal to perform a wake-up function. Since the stylus may consume power from a power storage device, for the sake of power-saving, the stylus may often stay in a power-saving mode. When the stylus detects the beacon signal, it can enter into a working mode with more power consumption.

In another example, the stylus can use the beacon signal to perform a signal-synchronized function. A touch sensitive processing apparatus which controls the touch panel may use different times to act in different detecting modes. For example, in a period, it executes a mutual-capacitive detecting to detect an external passive conducting object, such as a finger. In another period, it executes a detecting of electrical signal emitted from an active stylus. Multiple active styluses may be coordinated to emit the electrical signals in different periods. However, these works need the touch sensitive processing apparatus transmitting the beacon signal as the synchronous signal to inform the stylus.

According to experience, most of the time for an ordinary user holding a stylus is spent on think by letting tip of the stylus leave the touch panel or on moving his hand. Since the stylus mostly uses electrode of the tip to receive the beacon signal, when the tip is too far to the touch panel, the stylus cannot receive the beacon signal and thus enters into the power-saving mode after a period. However, the user does not know whether the stylus on hand has entered into the power-saving mode. When the user uses the stylus in the power-saving mode to touch the touch panel, it takes time for the stylus to revive to normal working state. Therefore, the leading trace for the stylus just touching the touch panel cannot be presented. This is not good to user experience.

Certainly, the emitting strength of the beacon signal can be strengthened to improve the receiving ability of the beacon signal of the stylus. However, the electronic devices of the touch panel may also consume power from a power storage device, and to strengthen the emitting strength of the beacon signal will reduce the available time of the electronic devices. Besides, to strengthen the emitting strength of the beacon signal will increase the probability that the touch panel interferes with other electronic devices. Thus, the present invention mainly concerns that how to improve the receiving ability of the beacon signal of the stylus hovering above the touch panel.

Referring to FIG. 1, it shows a schematic diagram of an electric current direction for a traditional stylus and a touch panel. In FIG. 1, penholder (or rod) or surface of the stylus 110 is made of conductor connecting to a local ground of the stylus. A capacitor A resides between the touch panel/screen 120 and the tip and the penholder of the stylus 110. A capacitor B resides between the stylus 110 and the ground. A capacitor C also resides between the electronic device and the ground.

The touch panel/screen 120 may include multiple first electrodes 121 being in parallel and multiple second electrodes 122 being in parallel. Multiple intersections of these two electrodes form sensing points of mutual-capacitive touch control. The beacon signal may be emitted by a part of or all the first electrodes 121 and/or the second electrodes 122, or other specific electrodes. The present invention does not limit the beacon signal or wireless radio frequency signal to be emitted by the first electrodes 121 and/or the second electrodes 122.

In FIG. 1, only one power loop influences the detecting ability of the circuits on the stylus to the beacon signal. The loop is constituted by the three capacitors A, B, and C in a serial connection sequentially. The voltage of the loop is supplied by the beacon signal, and the signal strength being able to be detected by the stylus 110 is about the voltage difference between the voltage received by the capacitor A and the local ground of the stylus. Accordingly, when the stylus 110 stays closer to the touch panel 120, it detects stronger signal. Conversely, the stylus 110 detects weaker signal when it is farther from the touch panel 120.

Referring to FIG. 2, it shows the schematic diagram of electric current directions for the traditional stylus and the touch panel. In FIG. 2, the penholder (or rod) or the surface of the stylus 110 is made of conductor connecting to the local ground of the stylus. A capacitor A resides between the touch panel/screen 120 and the tip and the penholder of the stylus 110. A capacitor B resides between the stylus 110 and the ground. A capacitor C resides between the electronic device and the ground. A hand 130 holds the penholder or the surface of the stylus 110 to form a capacitor D, and a capacitor E resides between the human body and the ground.

In FIG. 2, when the hand 130 holding the stylus 110 is far from the touch panel 120, the capacitance between the hand 130 and the touch panel 120 is small. Hence, the signal strength being able to be detected by the stylus 110 is about the voltage difference between the voltage received by the capacitor A and the local ground of the stylus 110. When the stylus 110 is closer to the touch panel 120, it detects stronger signal. Conversely, the stylus 110 detects weaker signal when it is farther from the touch panel 120.

Referring to FIG. 3, it shows the schematic diagram of electric current directions for the traditional stylus and the touch panel. Compared to FIG. 2, the hand 130 of FIG. 3 touches the touch panel 120 to form a capacitor F. Since the touch panel 120 additionally couples to the stylus 110 via the capacitor F, the hand 130, and the capacitor D, and when the hand 130 is a good conductor and receives the beacon signal of the touch panel 120, the voltage of the local ground of the stylus 110 is almost pulled to the voltage of the beacon signal received from the capacitor D because the local ground of the stylus 110 couples to the hand 130. Since the voltage of the beacon signal which the stylus 110 receives from the capacitor A and the voltage of the local ground of the stylus are dramatically pulled to be closer, causing the voltage difference to be quite small, the strength of the beacon signal detected by the stylus 110 becomes very weak consequently.

Even though the hand 130 holding the stylus 110 does not touch the touch panel 120, just in a quite distance, the capacitor F between the hand 130 and the touch panel 120 still has quite influence on the local ground of the stylus 110. When the stylus 110 is closer to the touch panel 120, the local ground of the stylus 110 is closer to the beacon signal emitted from the touch panel 120. Hence, when the distance between the stylus 110 and the touch panel 120 is a constant, and the hand 130 is closer to the touch panel 120, the signal detected by the stylus 110 is weaker. Conversely, when the hand 130 is farther from the touch panel 120, the signal detected by the stylus 110 is stronger.

Accordingly, how to improve the receiving ability of the beacon signal of the stylus hovering above the touch panel is one of the problems that the present invention intends to solve, particularly, the problem is that the stylus cannot detect the beacon signal in time when the hand holding the stylus approximates the touch panel/screen.

### SUMMARY OF THE INVENTION

According to one embodiment of the present invention, it provides a stylus for receiving a wireless radio frequency signal emitted from a touch panel or screen. The stylus includes: a rod, covered by dielectric material for user's handling; an electrode, receiving the wireless radio frequency signal; and a receiving circuit, coupled to the electrode, wherein the receiving circuit is placed inside the rod.

In one embodiment, for insulating the rod from user's handling to increase the ability of the receiving circuit for receiving the beacon signal or wireless radio frequency signal, the rod is constituted by dielectric material.

In one embodiment, for being convenient to the stylus to receive the beacon signal or wireless radio frequency signal, the electrode is one or any combination of the followings: an end electrode of a tip section of the stylus; a first ring electrode surrounding the tip section; and a second ring electrode surrounding the rod, wherein the tip section is a part of the stylus of which section area gradually becomes small. In one embodiment, for reducing the resistance of the electrode to increase receiving ability, the first ring electrode includes multiple independent electrodes configured to surround the tip section. In one embodiment, for reducing the resistance of the electrode to increase receiving ability, the second ring electrode includes multiple independent electrodes configured to surround the rod.

In one embodiment, for achieving mutual signal synchronizations between the stylus and the touch panel or screen, the stylus further includes: a driving circuit; and a processing circuit. The processing circuit connects the driving circuit and the receiving circuit. When the receiving circuit receives the wireless radio frequency signal, the processing circuit has the driving circuit at least send a driving signal via an end electrode of a tip section of the stylus to have a touch sensitive processing apparatus which connects to the touch panel or screen be able to analyze the driving signal for getting a relative position of the stylus to the touch panel or screen. In one embodiment, passive parts are used for simplifying the design of the stylus, power supply of the processing circuit, the receiving circuit, and the driving circuit comes from the wireless radio frequency signal received by the electrode. In one embodiment, for increasing the ability of the stylus to control the strength of and to modulate the driving signal, the stylus further includes a battery supplying power to the processing circuit, the receiving circuit, and the driving circuit.

According to one embodiment of the present invention, it provides an electronic system. The electronic system includes: an electronic device having a touch panel or screen; and a stylus for receiving a wireless radio frequency signal emitted from the touch panel or screen. The stylus includes: a rod, covered by dielectric material for user's handling; an electrode, receiving the wireless radio frequency signal; and a receiving circuit, coupled to the electrode, wherein the receiving circuit is placed inside the rod.

According to the stylus of the abovementioned embodiments, since it and the hand holding it (user's handling) show an insulating relation, it can increase the ability for receiving the beacon signal emitted from the touch panel or screen when the hand approaches or touches the touch panel or screen. Accordingly, the stylus can keep in active state in a farther distance to the touch panel or screen so that the consumption time for the stylus in sleeping state that just touches the touch panel or screen to revive to in active state can be avoided or reduced. By doing so, user experience can be improved.

The above description is only an outline of the technical schemes of the present invention. Preferred embodiments of the present invention are provided below in conjunction with the attached drawings to enable one with ordinary skill in the art to better understand said and other objectives, features and advantages of the present invention and to make the present invention accordingly.

### BRIEF DESCRIPTION OF THE DRAWINGS

The present invention can be more fully understood by reading the following detailed description of the preferred embodiments, with reference made to the accompanying drawings, wherein:

FIG. 1 shows a schematic diagram of an electric current direction for a traditional stylus and a touch panel;

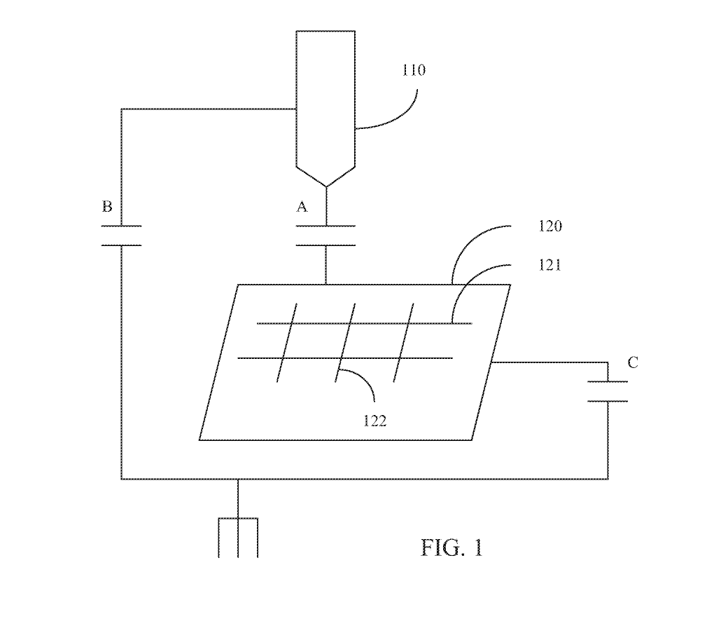

FIG. 2 shows a schematic diagram of electric current directions for the traditional stylus and the touch panel;

FIG. 3 shows a schematic diagram of electric current directions for the traditional stylus and the touch panel;

FIG. 4 shows a schematic diagram of electric current directions for a stylus and a touch panel according to an embodiment of the present invention;

FIG. 5 shows a schematic diagram of electric current directions for the stylus and the touch panel according to an embodiment of the present invention; and

FIG. 6 shows an electronic system according to an embodiment of the present invention.

### DETAILED DESCRIPTION OF THE PREFERRED EMBODIMENTS

Some embodiments of the present invention are described in detail below. However, in addition to the descriptions given below, the present invention can be applicable to other embodiments, and the scope of the present invention is not limited by such, rather by the scope of the claims. Moreover, for better understanding and clarity of the description, some components in the drawings may not necessary be drawn to scale, in which some may be exaggerated relative to others, and irrelevant parts are omitted.

If any terms in this application conflict with terms used in any application(s) from which this application claims priority, or terms incorporated by reference into this application or the application(s) from which this application claims priority, a construction based on the terms as used or defined in this application should be applied.

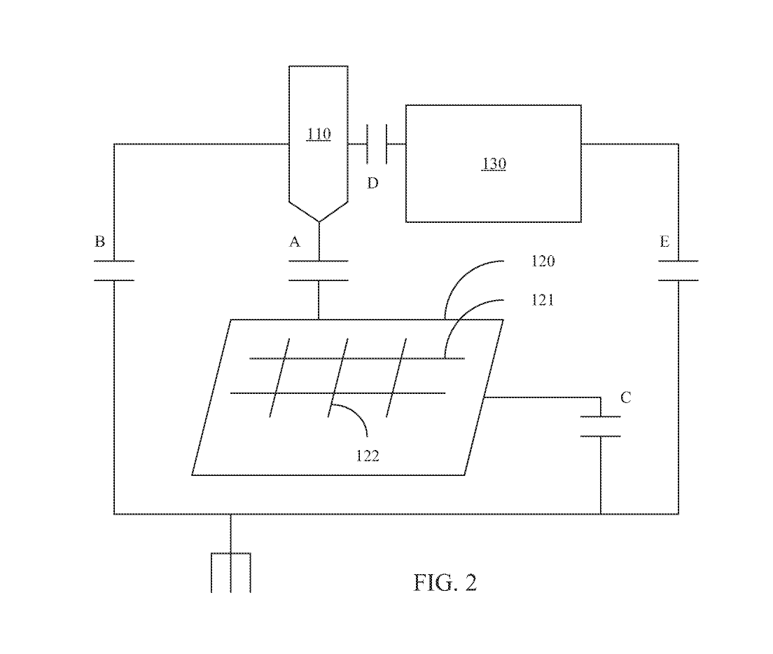

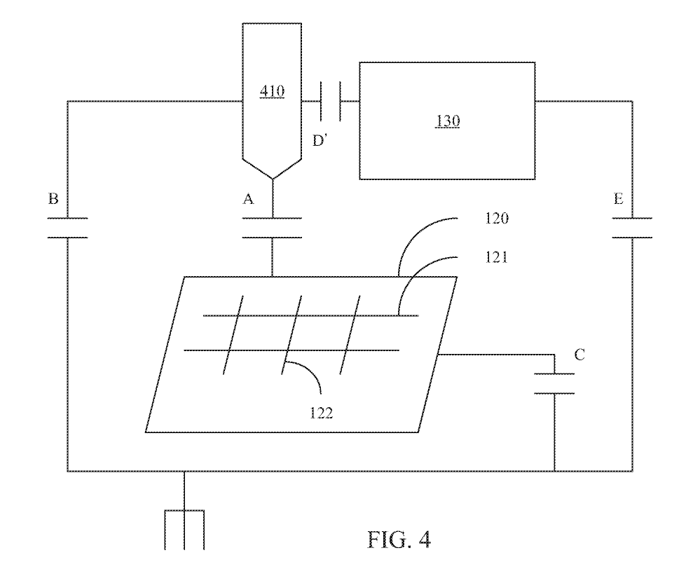

Referring to FIG. 4, it shows electric current directions for a stylus and a touch panel according to an embodiment of the present invention. The surface of the stylus 410 is made of insulating (or dielectric) material or the surface of the part of the stylus 410 which contacts with the hand 130 is made of insulating material. Compared to the current loops of FIG. 2, since the stylus 410 and the hand 130 in FIG. 4 are electrically decoupled, the capacitor D′ between the stylus 410 and the hand 130 is smaller than the capacitor D of FIG. 2. When the hand 130 holding the stylus 410 is far from the touch panel 120, the capacitance between the hand 130 and the touch panel 120 is small. Accordingly, the signal strength being able to be detected by the stylus 410 is the voltage difference about between the voltage received by the capacitor A and the voltage of the local ground of the stylus 410. When the stylus 410 is closer to the touch panel 120, it detects the signal stronger. Otherwise, when the stylus 410 is farther from the touch panel 120, it detects the signal weaker.

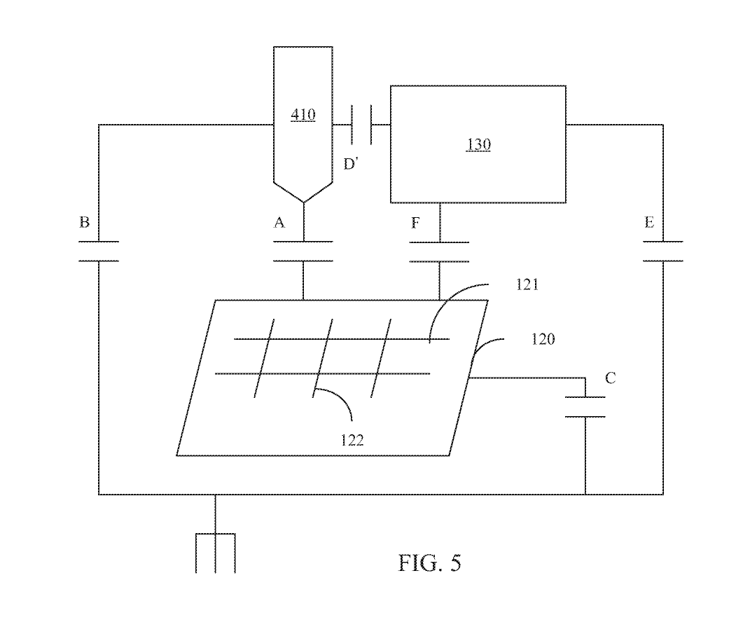

Referring to FIG. 5, it shows electric current directions for the stylus and the touch panel according to an embodiment of the present invention. Compared to FIG. 4, the hand 130 of FIG. 5 touches the touch panel 120 to form a capacitor F. Since the touch panel 120 additionally couples the stylus 410 via the capacitor F, the hand 130, and the capacitor D′, and when the hand 130 is a good conductor and receives the beacon signal of the touch panel 120, the influence on the voltage of the local ground of the stylus 410 which is affected by the voltage of the beacon signal received from the capacitor D′ is very small because the local ground of the stylus 410 does not couple to the hand 130 by contact but only capacitive coupling at most. Hence, the signal strength being able to be detected by the stylus 410 is the voltage difference about between the voltage received by the capacitor A and the voltage of the local ground of the stylus 410. When the stylus 410 is closer to the touch panel 120, it detects the signal stronger. Otherwise, when the stylus 410 is farther from the touch panel 120, it detects the signal weaker.

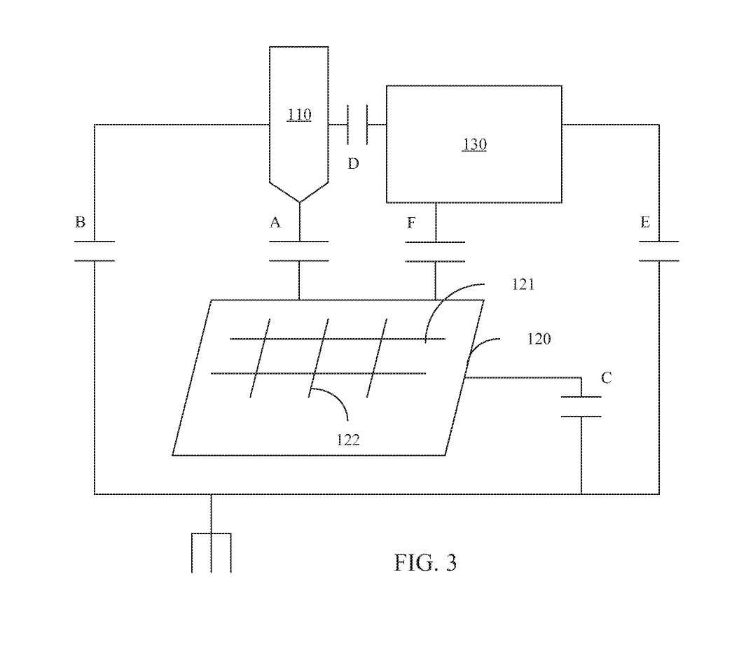

Similarly, the hand 130 holding the stylus 410 does not touch the touch panel 120, and even in a quite distance, the beacon signal received by the capacitor F between the hand 130 and the touch panel 120 has quite limited influence on the local ground of the stylus 410. When the stylus 410 is closer to the touch panel 120, it detects the signal stronger. Otherwise, when the stylus 410 is farther from the touch panel 120, it detects the signal weaker. Therefore, compared to the embodiment of FIG. 3, in the same situation, when an insulating (or dielectric) material is laid between the stylus 410 and the hand 130, the signal strength of the beacon signal detected by the stylus 410 of the embodiment of FIG. 5 would be comparatively much better. In other words, the stylus 410 can detect the beacon signal in a farther distance to the touch panel/screen 120 or has a better signal-to-noise ratio in the same distance to the touch panel/screen 120. That is, the receiving ability of the beacon signal of the stylus 410 hovering above the touch panel 120 is improved.

For insulating the stylus 410 from the hand 130 (user's handling), in one embodiment, the structure of the pen body of the stylus 410 is made of insulating (dielectric) material. In one embodiment, the surface of the stylus 410 is covered by insulating (dielectric) material.

For applying to various styluses 410 emitting electrical signals, in one embodiment, the stylus 410 may be the stylus emitting the electrical signal actively. In another embodiment, the stylus 410 may be the stylus emitting the electrical signal passively.

For sensing or detecting the beacon signal, sensing electrode(s) can be arranged at the place the stylus 410 is closer to the touch panel/screen 120 in using. In one embodiment, the stylus 410 can use the electrode of the tip section to sense or detect the beacon signal. In one embodiment, the stylus 410 can use the ring electrode surrounding the tip section to sense or detect the beacon signal. In one embodiment, the stylus 410 can use the electrode after the tip section to sense or detect the beacon signal.

A person having ordinary skill in the art will appreciate that the stylus 410 is not limited to receive only the beacon signal of the touch panel but also the driving signal(s) which the touch panel 120 transmit it/them via driving electrode(s). The beacon signal or the driving signal can be used not only for triggering but also for sending information to the stylus 410 in analog or digital way.

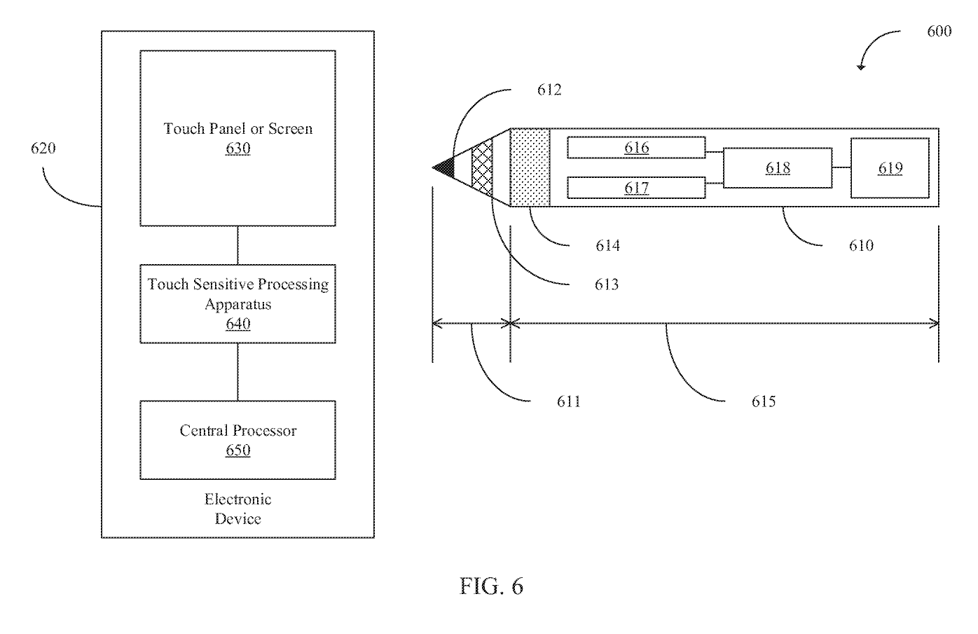

Referring to FIG. 6, it shows an electronic system 600 according to an embodiment of the present invention. The electronic system 600 includes a stylus 610 and an electronic device 620. The electronic device 620 includes a touch panel or screen 630, a touch sensitive processing apparatus 640 connecting to the touch panel or screen 630, and a central processor 650 connecting to the touch sensitive processing apparatus 640. The touch panel or screen 630 includes multiple first electrodes being in parallel and multiple second electrodes being in parallel. Multiple intersections of these two electrodes form sensing points of mutual capacitive touch control. The beacon signal emitted from the touch sensitive processing apparatus 640 may be emitted by a part of or all the first electrodes and/or the second electrodes, or other specific electrodes. The present invention does not limit the beacon signal or the wireless radio frequency signal to be emitted by the first electrodes and/or the second electrodes.

In one embodiments, after emitting the beacon signal or wireless radio frequency signal to synchronize the stylus 610, the touch sensitive processing apparatus 640 also receives electrical signal emitted by the stylus 610 via the first electrodes and/or the second electrodes so as to know a relative position of the stylus 610 to the touch panel or screen 630, and even states of the stylus 610, such as the pressure received by the tip section of the stylus 610, states of button(s) or sensor(s) on the stylus 610, and so on. Next, the touch sensitive processing apparatus 640 reports the information related to the stylus 610 to the operation system and application software that are executed by the central processor 650.

The stylus 610 includes a tip section 611 and a rod 615. The tip section 611 is a part whose section area gradually gets small, it may include an end electrode 612 and/or a first ring electrode 613 surrounding the tip section 611. The stylus 610 may include a second ring electrode 614 surrounding the rod 615. The first ring electrode 613 may be a single electrode or include multiple independent electrodes. The second ring electrode 614 may be a single electrode or include multiple independent electrodes. The rod 615 is covered by dielectric (insulating) material for user's hand to hold it. In one example, the rod 615 is constituted by dielectric (insulating) material. The present invention does not limit shape of the section areas of the tip section 611 and the rod 610 to be circle, and their section areas may be other shapes. Accordingly, the section areas of the first ring electrode 613 and the second ring electrode 614 may be circle or other closed shapes.

A receiving circuit 616 may be configured inside the rod 615. The receiving circuit 616 may connect to one of or all the end electrode 612, the first ring electrode 613, and the second electrode 614 to receive a wireless radio frequency signal emitted by the touch panel or screen 630.

A driving circuit 617 may be set up inside the rod 615 and connect to a processing circuit 618 which connects the driving circuit 617 and the receiving circuit 616. When the receiving circuit 616 receives the beacon signal or wireless radio frequency signal, the processing circuit 618 has the driving circuit 617 at least send a driving signal via an end electrode 612 of a tip section 611 of the stylus 610 to have the touch sensitive processing apparatus 640 which connects to the touch panel or screen 630 be able to analyze the driving signal for getting a relative position of the stylus 610 to the touch panel or screen 630.

In one embodiment, power supply of the processing circuit 618, the receiving circuit 616, and the driving circuit 617 comes from the wireless radio frequency signal received by the electrode in connection with the receiving circuit 616. In another embodiment, the stylus 610 further includes a battery 619 supplying power to the processing circuit 618, the receiving circuit 616, and the driving circuit 617.

According to one embodiment of the present invention, it provides a stylus for receiving a wireless radio frequency signal emitted from a touch panel or screen. The stylus includes: a rod, covered by dielectric material for user's handling; an electrode, receiving the wireless radio frequency signal; and a receiving circuit, coupled to the electrode, wherein the receiving circuit is placed inside the rod.

In one embodiment, for insulating the rod from user's handling (user's hand) to increase the ability of the receiving circuit for receiving the beacon signal or wireless radio frequency signal, the rod is constituted by dielectric material.

In one embodiment, for being convenient to the stylus to receive the beacon signal or wireless radio frequency signal, the electrode is one of or any combination of the followings: an end electrode of a tip section of the stylus; a first ring electrode surrounding the tip section; and a second ring electrode surrounding the rod, wherein the tip section is a part of the stylus of which section area gradually becomes small. In one embodiment, for reducing the resistance of the electrode to increase receiving ability, the first ring electrode includes multiple independent electrodes configured to surround the tip section. In one embodiment, for reducing the resistance of the electrode to increase receiving ability, the second ring electrode includes multiple independent electrodes configured to surround the rod.

In one embodiment, for achieving mutual signal synchronizations between the stylus and the touch panel or screen, the stylus further includes: a driving circuit; and a processing circuit. The processing circuit connects the driving circuit and the receiving circuit. When the receiving circuit receives the wireless radio frequency signal, the processing circuit has the driving circuit at least send a driving signal via an end electrode of a tip section of the stylus to have a touch sensitive processing apparatus which connects to the touch panel or screen be able to analyze the driving signal for getting a relative position of the stylus to the touch panel or screen. In one embodiment, passive parts are used for simplifying the design of the stylus, power supply of the processing circuit, the receiving circuit, and the driving circuit comes from the wireless radio frequency signal received by the electrode. In one embodiment, for increasing the ability of the stylus to control the strength of and to modulate the driving signal, the stylus further includes a battery supplying power to the processing circuit, the receiving circuit, and the driving circuit.

In one embodiment, the present invention provides an electronic system. The electronic system includes: an electronic device having a touch panel or screen; and a stylus for receiving a wireless radio frequency signal emitted from the touch panel or screen. The stylus includes: a rod, covered by dielectric material for user's handling; an electrode, receiving the wireless radio frequency signal; and a receiving circuit, coupled to the electrode, wherein the receiving circuit is placed inside the rod.

According to the stylus of the abovementioned embodiments, since it and the hand holding it (user's handling) show an insulating relation, it can increase the ability for receiving the beacon signal emitted from the touch panel or screen when the hand approaches or touches the touch panel or screen. Accordingly, the stylus can keep in active state in a farther distance to the touch panel or screen so that the consumption time for the stylus in sleeping state that just touches the touch panel or screen to revive to in active state can be avoided or reduced. By doing so, user experience can be improved.

The above embodiments are only used to illustrate the principles of the present invention, and they should not be construed as to limit the present invention in any way. The above embodiments can be modified by those with ordinary skill in the art without departing from the scope of the present invention as defined in the following appended claims.

What is claimed is:

1. A stylus for receiving a wireless radio frequency signal emitted from a touch panel or screen, the stylus comprising:
a rod, covered by dielectric material for user's handling;
an electrode, receiving the wireless radio frequency signal; and
a receiving circuit, coupled to the electrode, wherein the receiving circuit is placed inside the rod.

2. The stylus of claim 1, wherein the rod is constituted by dielectric material.

3. The stylus of claim 1, wherein the electrode is one or any combination of the followings:
an end electrode of a tip section of the stylus;
a first ring electrode surrounding the tip section; and
a second ring electrode surrounding the rod,
wherein the tip section is a part of the stylus of which section area gradually becomes small.

4. The stylus of claim 3, wherein the first ring electrode comprises a plurality of independent electrodes configured to surround the tip section.

5. The stylus of claim 3, wherein the second ring electrode comprises a plurality of independent electrodes configured to surround the rod.

6. The stylus of claim 1, further comprising:
a driving circuit; and
a processing circuit, connecting the driving circuit and the receiving circuit, wherein when the receiving circuit receives the wireless radio frequency signal, the processing circuit has the driving circuit at least send a driving signal via an end electrode of a tip section of the stylus to have a touch sensitive processing apparatus which connects to the touch panel or screen be able to analyze the driving signal for getting a relative position of the stylus to the touch panel or screen.

7. The stylus of claim 6, wherein power supply of the processing circuit, the receiving circuit, and the driving circuit comes from the wireless radio frequency signal received by the electrode.

8. The stylus of claim 6, further comprising:
a battery, supplying power to the processing circuit, the receiving circuit, and the driving circuit.

9. An electronic system, comprising:
an electronic device, having a touch panel or screen; and
a stylus, receiving a wireless radio frequency signal emitted from the touch panel or screen, the stylus comprising:
a rod, covered by dielectric material for user's handling;
an electrode, receiving the wireless radio frequency signal; and
a receiving circuit, coupled to the electrode, wherein the receiving circuit is placed inside the rod.

10. The electronic system of claim 9, wherein the stylus further comprises:
a driving circuit; and
a processing circuit, connecting the driving circuit and the receiving circuit, wherein when the receiving circuit receives the wireless radio frequency signal, the processing circuit has the driving circuit at least send a driving signal via an end electrode of a tip section of the stylus to have a touch sensitive processing apparatus which connects to the touch panel or screen be able to analyze the driving signal for getting a relative position of the stylus to the touch panel or screen.
